(19) United States
(12) Patent Application Publication
(10) Pub. No.: US 2014/0141738 A1
(43) Pub. Date: May 22, 2014

(54) SELF-TUNING AMPLIFICATION DEVICE

(71) Applicant: RF MICRO DEVICES, INC., Greensboro, NC (US)

(72) Inventor: Stephen T. Janesch, Greensboro, NC (US)

(73) Assignee: RF Micro Devices, Inc., Greensboro, NC (US)

(21) Appl. No.: 13/860,101

(22) Filed: Apr. 10, 2013

Related U.S. Application Data
(60) Provisional application No. 61/727,970, filed on Nov. 19, 2012.

(51) Int. Cl. H04B 1/10

(52) U.S. Cl. CPC H04B 1/10
USPC 455/192.2

(57) ABSTRACT

Radio frequency (RF) self-tuning amplification devices and methods of amplification for an RF input signal are disclosed. In one embodiment, the RF self-tuning amplification device has a first RF amplifier, a reference RF amplifier, and a tuning circuit. The first RF amplifier includes a first RF amplification circuit to generate an amplified RF output signal from the RF input signal, and a tunable parallel resonator tunable so as to shift an RF output signal phase of the amplified RF output signal. The reference RF amplifier includes a second RF amplification circuit that generates a reference RF signal from the RF input signal, and a resistive load, so that the reference RF signal has a reference RF signal phase. The tuning circuit is configured to tune the tunable parallel resonator to reduce a phase difference between the RF output signal phase and the reference RF signal phase.

### RELATED APPLICATION

This application claims the benefit of U.S. Provisional Patent Application Ser. No. 61/727,970, filed on Nov. 19, 2012 and entitled “SELF-TUNING AMPLIFIER,” the disclosure of which is hereby incorporated herein by reference in its entirety.

### FIELD OF THE DISCLOSURE

This disclosure relates generally to radio frequency (RF) amplification devices and methods of operating the same.

### BACKGROUND

An increasingly important consideration in radio frequency (RF) design is versatility. There is an increasing demand for user communication devices (such as cellular phones, tablets, laptops, etc.) that provide more and faster communication services. A user communication device, such as a cellular phone, may need to operate in multiple RF cellular bands in addition to other RF communication bands assigned for Wide Local Area Network (WLAN) services, Bluetooth® services, Global Positioning System (GPS) services, FM radio broadcasts, Digital Video Broadcasting (DVB) services, and/or the like. Of course, the most straightforward technique is to simply provide individual circuitry in the user communication device for each service. However, this is also likely to significantly increase the size and cost of the user communication device. Accordingly, RF devices in the user communication device need to be able to function in different RF communication bands to provide different RF communication services.

RF amplification devices are one type of RF device commonly used in front-end transceiver modules. These RF amplification devices may provide amplification to an RF receive signal received by an antenna. In addition, these RF amplification devices may also amplify RF transmission signals for emission by the antenna. To configure these devices to provide amplification in multiple RF communication bands, these RF amplification devices often use fixed broadband RF filters. These fixed broadband RF filters have frequency responses that define passbands wide enough to fit multiple different RF communication bands. Unfortunately, this comes at the expense of an increase in noise and a decrease in power performance. The fixed broadband RF filter does not provide much filtering of noise within or between the different RF communication bands. Also, the power performance of the RF amplification device suffers because the fixed broadband RF filter cannot provide impedance matching at the various frequencies.

Therefore, what is needed is a versatile RF amplification device more immune to noise and/or with better power performance.

### SUMMARY

This disclosure relates to radio frequency (RF) self-tuning amplification devices and methods of amplification for an RF input signal operating at an RF signal frequency. The RF self-tuning amplification devices may provide precision tuning within an RF communication band and/or provide RF band tuning to a plurality of different RF communication bands. In one embodiment of an RF self-tuning amplification device, the RF self-tuning amplification device includes a first RF amplifier and a reference RF amplifier. The first RF amplifier includes a first RF amplification circuit configured to amplify the RF input signal so that the first RF amplifier generates an amplified RF output signal with an RF output signal phase and a tunable parallel resonator. The tunable parallel resonator is coupled in shunt with respect to the first RF amplification circuit, and is tunable so as to adjust the RF output signal phase of the amplified RF output signal.

The reference RF amplifier includes a second RF amplification circuit and a resistive load. The second RF amplification circuit is configured to amplify the RF input signal to generate a reference RF signal. The resistive load is operably associated with the second RF amplification circuit such that the reference RF signal is generated with a reference RF signal phase. Due to the resistive load, the reference RF signal phase is at a value at which the RF output signal phase would be provided for maximum power transfer. A tuning circuit is configured to tune the tunable parallel resonator and adjust the RF output signal phase so as to reduce a phase difference between the RF output signal phase and the reference RF signal phase. In this manner, the self-tuning amplification device self-tunes and increases the power transfer output of the amplified RF output signal.

Those skilled in the art will recognize improvements and modifications to the preferred embodiments of the present disclosure. All such improvements and modifications are considered within the scope of the concepts disclosed herein and the claims that follow.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram of one embodiment of a radio frequency (RF) self-tuning amplification device having a first RF amplifier, a reference RF amplifier, and a tuning circuit, wherein the first RF amplifier includes a first RF amplification circuit that amplifies an RF input signal so as to generate an amplified RF output signal, and a tunable parallel resonator that is tunable so as to shift an RF output signal phase of the RF output signal. The reference RF amplifier includes a second RF amplification circuit that amplifies the RF input signal so as to generate a reference RF signal and a resistive load operably associated with the second RF amplification circuit so that the reference RF signal has a reference RF signal phase. The tuning circuit is configured to tune the tunable parallel resonator and adjust the RF output signal phase so as to reduce a phase difference between the RF output signal phase and the reference RF signal phase.

FIG. 2A is a graph illustrating one embodiment of the RF input signal and one embodiment of an impedance response provided by the tunable parallel resonator in a frequency domain, prior to tuning by the tuning circuit.

FIG. 2B illustrates one embodiment of the amplified RF output signal in the frequency domain prior to tuning by the tuning circuit.

FIG. 2C is a graph illustrating the RF input signal and the impedance response in the frequency domain after tuning by the tuning circuit.

FIG. 2D is a graph illustrating the amplified RF output signal in the frequency domain after tuning by the tuning circuit.

FIG. 2E illustrates the RF input signal and the impedance response of the tunable parallel resonator in the frequency domain along with a plurality of different RF communication bands, where both the RF input signal and an impedance band defined by the impedance response are in one of the plurality of different RF communication bands.

FIG. 2F illustrates the RF input signal and the impedance response in the frequency domain once the RF input signal has been set to another RF communication band.

FIG. 2G illustrates the RF input signal and the impedance response in the frequency domain after the impedance band defined by the impedance response has been shifted into the other RF communication band.

FIG. 3 is a circuit diagram of one exemplary embodiment of the RF self-tuning amplification device shown in FIG. 1.

FIG. 4 is a circuit diagram of one embodiment of the RF self-tuning amplification device.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The disclosure generally relates to radio frequency (RF) self-tuning amplification devices and methods of amplification. Embodiments of the RF self-tuning amplification devices may provide precision tuning within an RF communication band and/or may provide tuning to any one of a plurality of different RF communication bands. In this manner, the RF self-tuning amplification device may be configured to provide narrow band performance in comparison to the size of an RF frequency band or bands. This narrow band performance decreases noise and can improve power performance without requiring matching networks and/or the like.

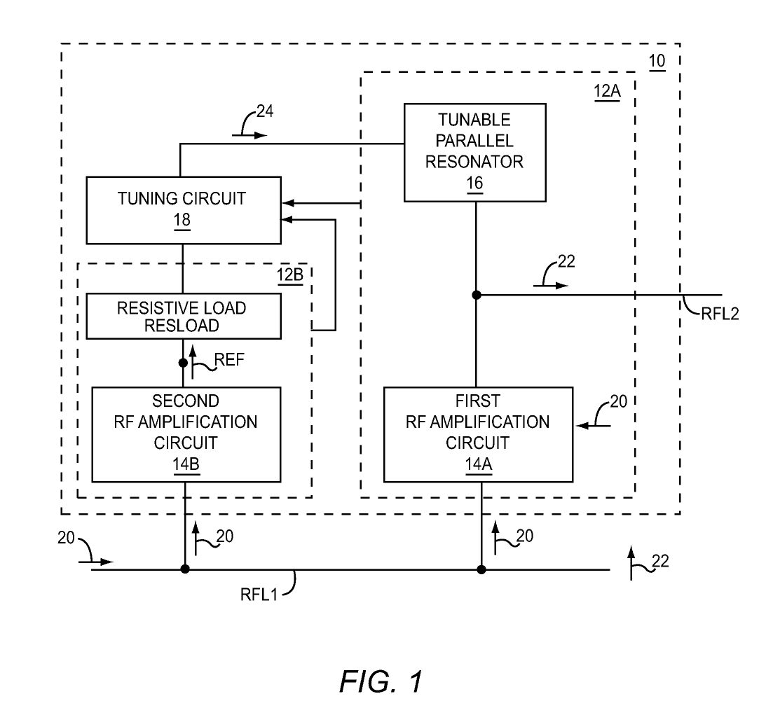

FIG. 1 is a block diagram of one embodiment of an RF self-tuning amplification device 10. The RF self-tuning amplification device 10 includes a first RF amplifier 12A and a reference RF amplifier 12B. The first RF amplifier 12A includes a first RF amplification circuit 14A, while the reference RF amplifier 12B includes a second RF amplification circuit 14B. In this embodiment, the first RF amplification circuit 14A and the second RF amplification circuit 14B are substantially identical. The first RF amplifier 12A also includes a tunable parallel resonator 16. The tunable parallel resonator 16 has a frequency response that defines a parallel resonant frequency. As such, the tunable parallel resonator 16 has an impedance peak at the parallel resonant frequency. Ideally, the impedance peak is infinite and the parallel resonant frequency operates as an open circuit at the parallel resonant frequency. In practice, the impedance peak may simply be high enough to provide a sufficiently high quality (Q) factor to meet design specifications for one or more RF communication bands. As explained in further detail below, the RF self-tuning amplification device 10 has a tuning circuit 18 configured to tune the tunable parallel resonator 16 and shift the parallel resonant frequency.

The first RF amplifier 12A is operable to receive an RF input signal 20 and output an amplified RF output signal 22. The RF input signal 20 operates at an RF signal frequency within an RF communication band. The RF input signal 20 may be received from upstream RF circuitry coupled to RF line RFL1 and the amplified RF output signal 22 may be output to downstream RF circuitry coupled to RF line RFL2. The first RF amplification circuit 14A of the first RF amplifier 12A is configured to amplify the RF input signal 20 so that the first RF amplifier 12A generates the amplified RF output signal 22 with an RF output signal phase. The amplifier gain of the first RF amplification circuit 14A may be fixed or variable.

The RF output signal phase is determined in accordance with an output source impedance seen into the first RF amplifier 12A and an output load impedance seen out of the first RF amplifier 12A. The output source impedance and the output load impedance are both complex impedances. When an output source impedance phase of the output source impedance seen into the first RF amplifier 12A is approximately equal to a negative of the output load impedance phase of the output load impedance seen out of the first RF amplifier 12A, the RF output signal phase is set at a value at which the amplified RF output signal 22 transfers maximum power to the downstream RF circuitry. Preferably, the output source impedance is equal to a complex conjugate of the output load impedance to achieve the greatest amount of power efficiency. On the other hand, when the output source impedance phase of the output source impedance seen into the first RF amplifier 12A is not approximately equal to the negative of the output load impedance phase of the output load impedance seen out of the first RF amplifier 12A, the amplified RF output signal 22 does not transfer maximum power to the downstream RF circuitry.

The tunable parallel resonator 16 is coupled in shunt with respect to the first RF amplification circuit 14A, and is tunable so as to adjust the RF output signal phase of the amplified RF output signal 22. Since the impedance peak of the tunable parallel resonator 16 occurs at the parallel resonant frequency, the amplified RF output signal 22 has a magnitude peak when the parallel resonant frequency is set to the RF signal frequency of the RF input signal 20. Accordingly, none or very little of the amplified RF output signal 22 is lost in the tunable parallel resonator 16 if the parallel resonant frequency is set to the RF signal frequency. The magnitude peak occurs when the output source impedance phase of the output source impedance seen into the first RF amplifier 12A is approximately equal to the negative of the output load impedance phase of the output load impedance seen out of the first RF amplifier 12A. In this case, reactive impedances of the output source impedance and the output load impedance cancel each other out and power is transferred as if there were only resistive impedances. As such, when the first RF amplifier 12A operates as if there were only resistive impedances, the RF output signal phase is set at the value at which the amplified RF output signal 22 transfers maximum power to the downstream RF circuitry.

To provide a reference for the RF output signal phase when the first RF amplifier 12A operates as if there were only resistive impedances, the RF self-tuning amplification device 10 includes the reference RF amplifier 12B. The reference RF amplifier 12B is operable to receive the RF input signal 20 and generate a reference RF signal REF. More particularly, the second RF amplification circuit 14B of the reference RF amplifier 12B is configured to amplify the RF input signal 20 so that the reference RF amplifier 12B generates the reference RF signal REF. In this embodiment, the first RF amplification circuit 14A is identical to the second RF amplification circuit 14B. However, the reference RF amplifier 12B includes a resistive load RESLOAD that is operably associated with the second RF amplification circuit 14B such that the reference RF signal REF is generated by the reference RF amplifier 12B with a reference RF signal phase. The resistive load RESLOAD has a substantially resistive impedance. More specifically, if parasitic inductances and capacitances are ignored, the resistive load RESLOAD has a purely real impedance. Accordingly, the reference RF signal phase is generated at or near the value of the RF output signal phase at which the amplified RF output signal 22 transfers maximum power to downstream RF circuitry.

To allow for improvements in power transfer, the tunable parallel resonator 16 is tunable so as to adjust the RF output signal phase of the amplified RF output signal 22. The tuning circuit 18 is configured to tune the tunable parallel resonator 16 and adjust the RF output signal phase so as to reduce a phase difference between the RF output signal phase and the reference RF signal phase. In this embodiment, the tuning circuit 18 is configured to tune the tunable parallel resonator 16 so as to substantially eliminate the phase difference between the RF output signal phase and the reference RF signal phase. In this manner, power transfer is maximized. The tuning circuit 18 may be operably associated with both the first RF amplifier 12A and the reference RF amplifier 12B.

The first RF amplification circuit 14A and the second RF amplification circuit 14B may be any type of circuit configured to amplify the RF input signal 20, and may include a transistor or a network of transistors in order to provide amplification to the RF input signal 20. Ideally, a signal level of the amplified RF output signal 22 can be expressed as a signal level of the RF input signal 20 multiplied by the amplifier gain of the first RF amplification circuit 14A. The RF input signal 20 operates at an RF signal frequency. The RF signal frequency of the RF input signal 20 may be defined in various ways, depending on a particular application of the RF self-tuning amplification device 10. For example, the RF signal frequency may be a center frequency of a frequency spectrum of the RF input signal 20, a frequency at a peak of the frequency spectrum, or a carrier wave frequency of the RF input signal 20. Note that these definitions of the RF signal frequency are not necessarily mutually exclusive. More than one, or all, of the definitions may apply for a particular RF input signal 20. If multiple definitions apply in a particular application, but are inconsistent with one another, the RF signal frequency of the RF input signal 20 would be characterized by the definition prescribed by the technical requirements and application parameters for the application.

As explained in further detail below, the tunable parallel resonator 16 may be any type of tunable parallel resonator. For example, the tunable parallel resonator 16 may be provided by passive reactive elements or active reactive elements. In either case, the frequency response of the tunable parallel resonator 16 defines the impedance peak at the parallel resonant frequency. By coupling the tunable parallel resonator 16 in shunt, the impedance peak provides maximum power transfer. The tunable parallel resonator 16 is tunable such that the parallel resonant frequency is shiftable, and shifting the parallel resonant frequency adjusts the RF output signal phase. By transposing the parallel resonant frequency, the tuning circuit 18 shifts the parallel resonant frequency, and thus the RF output signal phase, to reduce the phase difference between the RF output signal phase of the amplified RF output signal 22 and the reference RF signal phase of reference RF signal REF.

The first RF amplifier 12A and the reference RF amplifier 12B may be formed in the device layer of one or more semiconductor substrates. The one or more semiconductor substrates may be any suitable type of semiconductor substrate, such as a Silicon-based substrate, a Gallium Arsenide-based substrate, a sapphire-based substrate, a Germanium-based substrate, and/or the like.

The tuning circuit 18 is operably associated with the tunable parallel resonator 16 so as to tune the tunable parallel resonator 16. In this embodiment, the tuning circuit 18 generates a tuning control signal 24 having a control signal level. The parallel resonant frequency of the tunable parallel resonator 16 is set in accordance with the control signal level of the tuning control signal 24. In this particular embodiment, the tuning circuit 18 is operable to adjust the control signal level of the tuning control signal 24 to shift the RF output signal phase of the amplified RF output signal 22 so as to substantially eliminate the phase difference between the RF output signal phase and the reference RF signal phase.

The RF self-tuning amplification device 10 may be provided in a receiver chain of a transceiver to provide amplification. In this case, the RF input signal 20 may originally have been received on an antenna, and thus may require amplification for further processing by downstream RF circuitry within the receiver chain. The tunable parallel resonator 16 allows for self-tuning for various types of communication services. Thus, as the RF input signal 20 is switched among the various RF communication bands that may be processed by the receiver chain, the tunable parallel resonator 16 automatically self-tunes so that amplification can be provided for the specific communication service. The same may be true for the RF self-tuning amplification device 10 when implemented in a transmission chain.

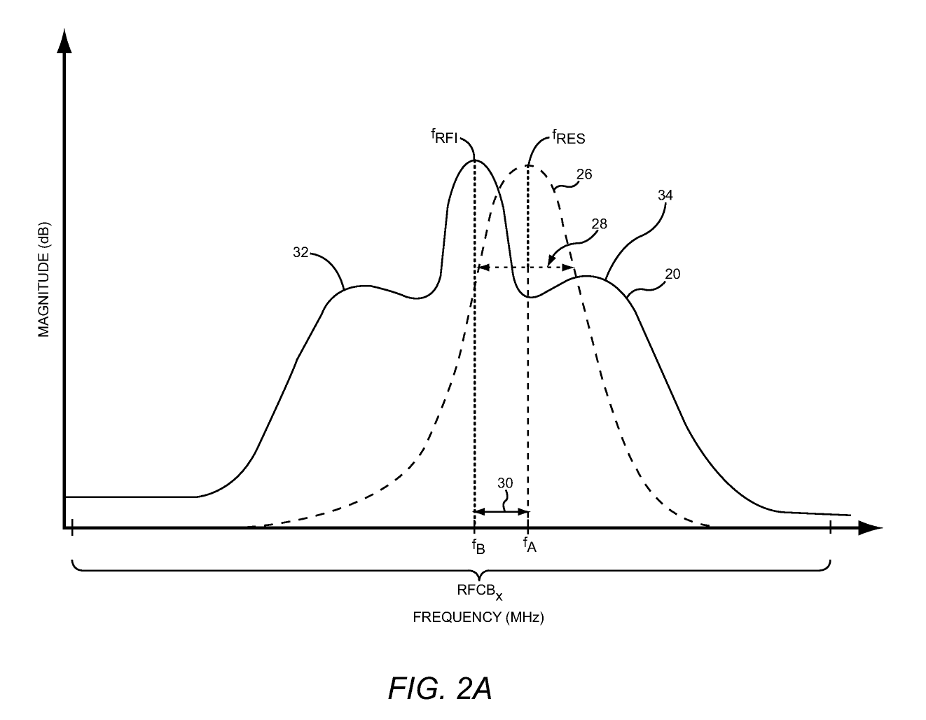

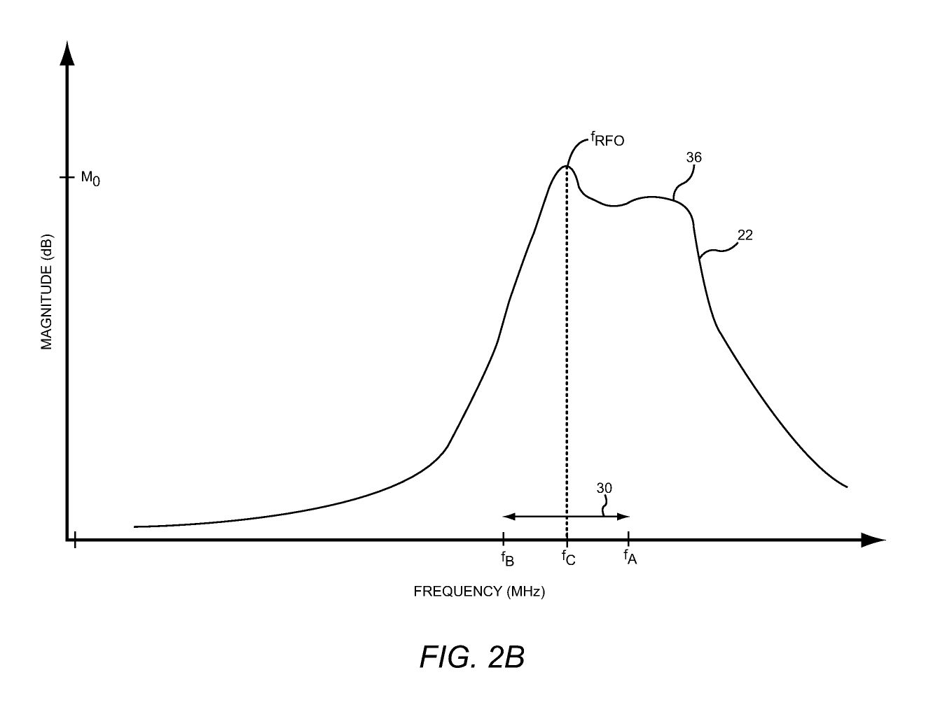

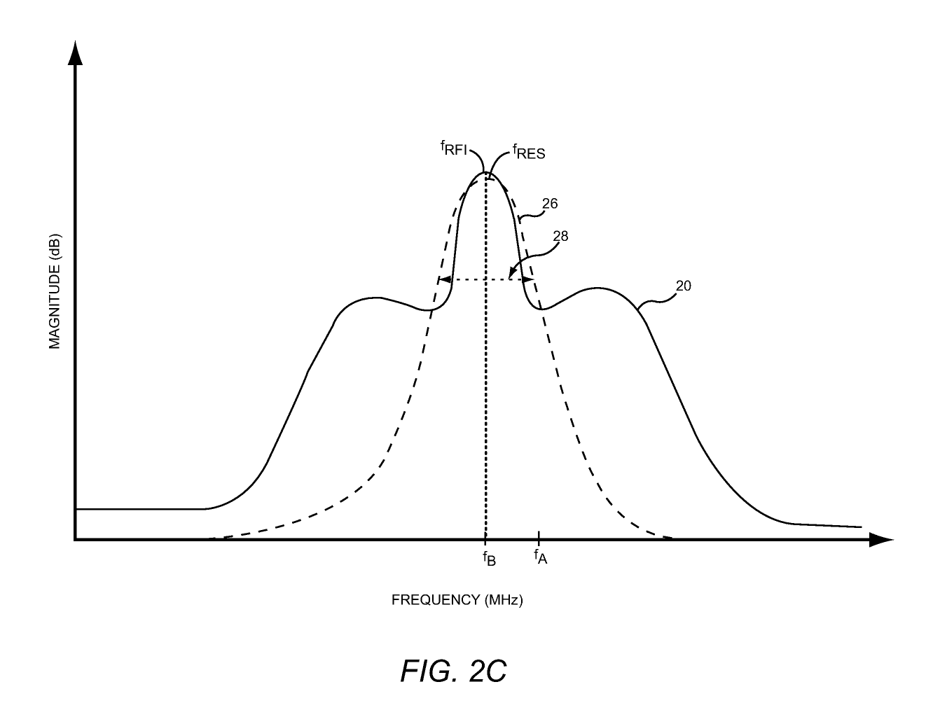

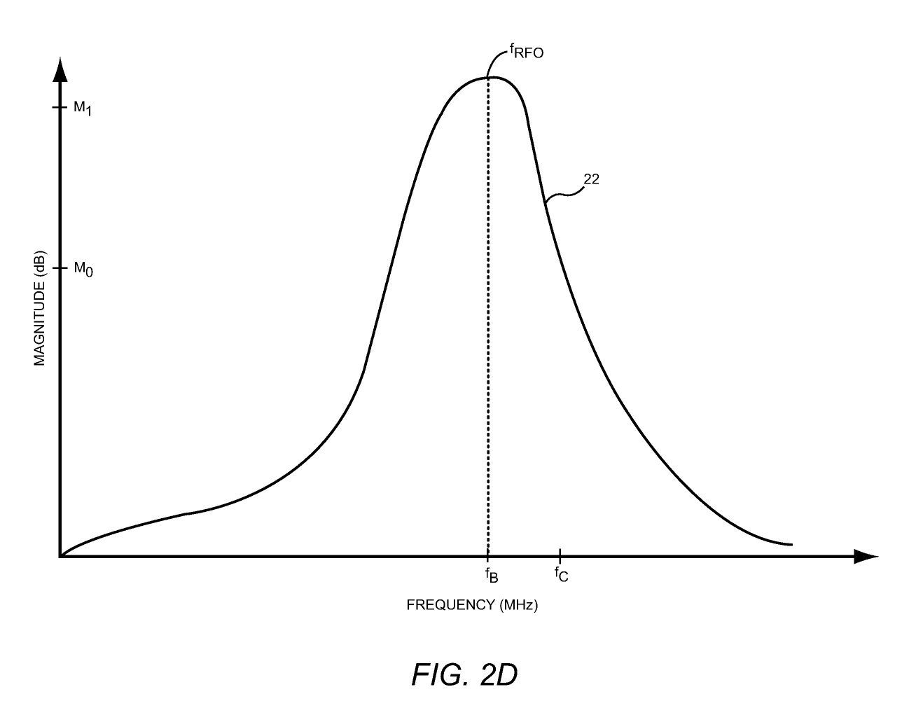

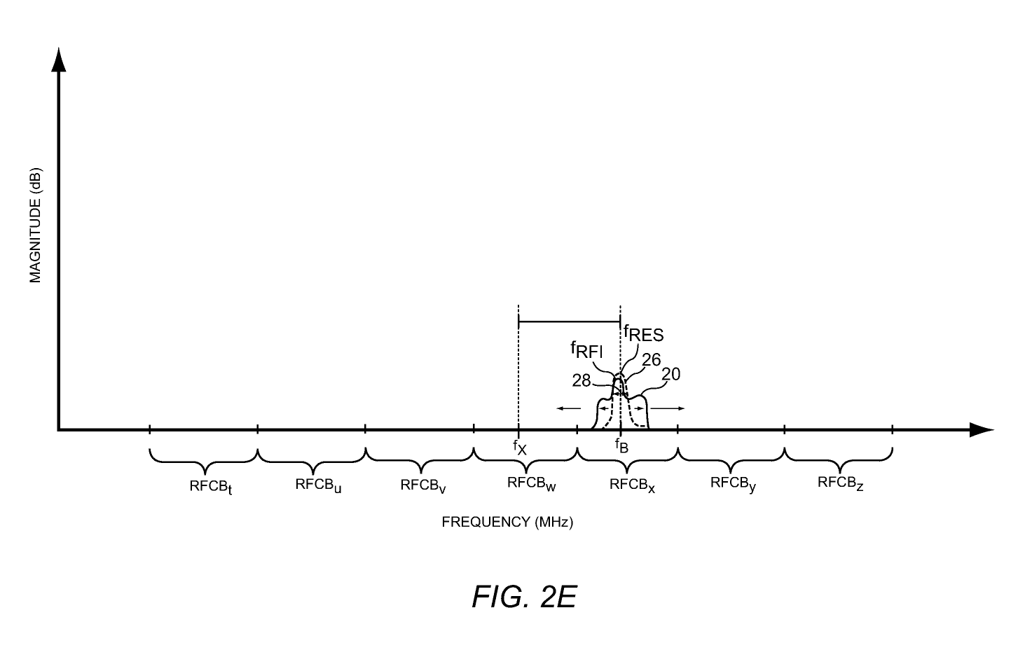

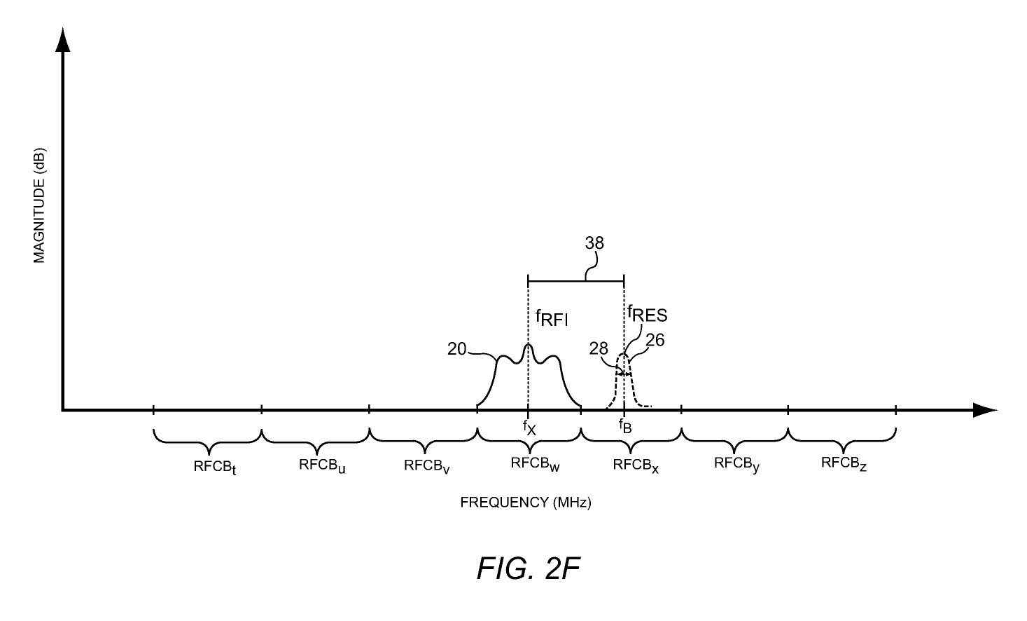

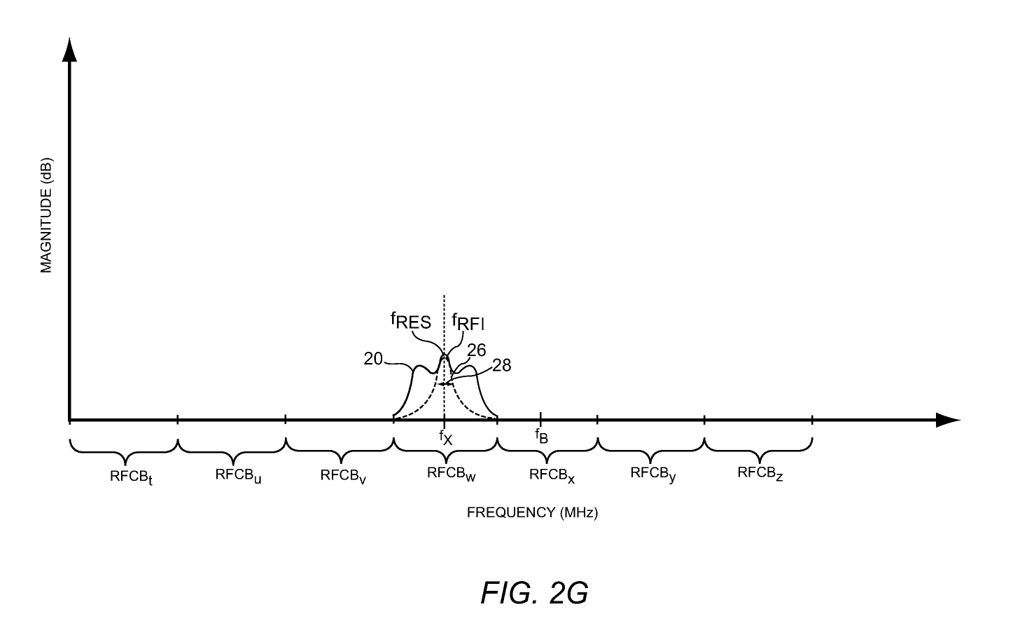

Referring now to FIG. 1 and FIGS. 2A-2E, FIG. 2A is a graph illustrating one embodiment of the RF input signal 20 and one embodiment of an impedance response 26 provided by the tunable parallel resonator 16 in the frequency domain. Also, the RF input signal 20 is illustrated by its frequency spectrum. Note that the RF input signal 20 operates at the RF signal frequency f_{RFI}. In other words, the frequency spectrum of the RF input signal 20 has a magnitude peak, and this magntitude peak corresponds to the RF signal frequency f_{RFI}. In this example, the RF signal frequency f_{RFI} is positioned at a frequency f_{B} within the frequency domain.

The impedance response 26 provided by the tunable parallel resonator 16 defines a parallel resonant frequency f_{RES}. This is the frequency that causes the tunable parallel resonator 16 to resonate. The impedance response 26 provided by the tunable parallel resonator 16 peaks at the parallel resonant frequency f_{RES}. In this embodiment, the parallel resonant frequency f_{RES} is positioned in the frequency domain at frequency f_{A}. Note that in FIG. 2A, the impedance response 26 defines an impedance band 28 that peaks at the parallel resonant frequency f_{RES}. The impedance band 28 is characterized as the range of frequencies corresponding to impedance magnitudes within 3 dB of the impedance peak of the impedance response 26. As mentioned above, the impedance peak of the impedance response 26 corresponds to the parallel resonant frequency f_{RES}. In FIG. 2A, there is a difference 30 between the RF signal frequency f_{RFI} of the RF input signal 20 and the parallel resonant frequency f_{RES} of the impedance response 26. Since the parallel resonant frequency f_{RES} is at the frequency f_{A} and the RF signal frequency f_{RFI} of the RF input signal 20 is at the frequency f_{B}, the difference 30 is equal to an absolute value of the frequency f_{A} minus the frequency f_{B}. When the parallel resonant frequency f_{RES} and the RF signal frequency f_{RFI} are misaligned, less power is transferred and/or more noise is produced by the RF self-tuning amplification device 10.

Note that the RF input signal 20 has a lobe 32 and a lobe 34. These lobes 32, 34 are the result of distortion, and are thus simply considered to be noise. However, due to the misalignment between the parallel resonant frequency f_{RES} and the RF signal frequency f_{RFI}, the lobe 34 is partially within the impedance band 28. This results in the RF self-tuning amplification device 10 providing a noisier signal to the downstream RF circuitry. Furthermore, the misalignment results in a smaller portion of the RF input signal 20 being within the impedance band 28 of the impedance response 26. Consequently, this results in less power being transferred to the downstream RF circuitry. As the difference 30 is augmented, the power performance and the noise performance of the RF self-tuning amplification device 10 degrade.

The RF input signal 20 and the impedance response 26 shown in FIG. 2A are provided within an RF communication band RFCBₓ. The RF communication band RFCBₓ includes the RF signal frequency f_{RFI}. The RF communication band RFCBₓ thus includes the magnitude peak of the RF input signal 20. The impedance response 26 of the tunable parallel resonator 16 has a relatively narrow band response with respect to the RF communication band RFCBₓ. For example, the impedance band 28 of the impedance response 26 is configured to be relatively narrow, so that only, or not much more than, the desired portions of the RF input signal 20 can fit within the impedance band 28. Using the narrow impedance band 28 is advantageous, since more noise can be filtered from the RF input signal 20. However, due to the narrowness of the impedance band 28, the alignment between the impedance response 26 and the RF input signal 20 becomes more important.

FIG. 2B illustrates one embodiment of the amplified RF output signal 22 in the frequency domain before the phase difference between the RF output signal phase and the reference RF signal phase is reduced. The amplified RF output signal 22 operates at an RF signal frequency f_{RFO} In the frequency domain, the RF signal frequency f_{RFO} is at frequency f_{C}. The RF signal frequency f_{RFO} is a magnitude peak in the frequency spectrum of the amplified RF output signal 22. As described above, the first RF amplification circuit 14A amplifies the RF input signal 20 in accordance with a gain. As shown in FIG. 2B, the amplified RF output signal 22 is then filtered in accordance with the impedance response 26 of the tunable parallel resonator 16. The amplified RF output signal 22 has been distorted and has less power as a result of the phase difference between the RF output signal phase and the reference RF signal phase. The phase difference results in the difference 30 between the parallel resonant frequency f_{RES} and the RF signal frequency f_{RFI} of the RF input signal 20.

As shown in FIG. 2B, the frequency spectrum of the amplified RF output signal 22 has a lobe 36 due to the lobe 34 of the RF input signal 20 being within the impedance band 28. Consequently, the amplified RF output signal 22 has some distortion, and power has been wasted, amplifying noise. Furthermore, since a smaller portion of the RF input signal 20 is within the impedance band 28, the magnitude peak at the RF signal frequency f_{RFO} is lower than it should be. Currently, the magnitude peak at the RF signal frequency f_{RFO} is at magnitude M₀. Note also that the RF signal frequency f_{RFO} of the amplified RF output signal 22 is at the frequency f_{C}. Accordingly, this represents a frequency misalignment between the amplified RF output signal 22 and the RF input signal 20. This misalignment is the result of the phase difference between the RF output signal phase and the reference RF signal phase, which indicates that the tunable parallel resonator 16 is not providing appropriate matching to the downstream RF circuitry. To provide precision tuning within the RF communication band RFCBₓ, the tuning circuit 18 is configured to tune the tunable parallel resonator 16 such that the parallel resonant frequency f_{RES} is shifted to reduce the difference 30 between the parallel resonant frequency f_{RES} and the RF signal frequency f_{RFI} of the RF input signal 20.

FIG. 2C is a graph illustrating the RF input signal 20 and the impedance response 26 provided by the tunable parallel resonator 16 after the tuning circuit 18 has tuned the tunable parallel resonator 16 to reduce the phase difference between the RF output signal phase and the reference RF signal phase has been reduced. As shown in FIG. 2C, the tuning circuit 18 has tuned the tunable parallel resonator 16 so as to substantially eliminate the difference 30 (shown in FIGS. 2A and 2B) between the parallel resonant frequency f_{RES} and the RF signal frequency f_{RFI} of the RF input signal 20. In this embodiment, the difference 30 has been completely eliminated, and the parallel resonant frequency f_{RES} of the impedance response 26 and the RF signal frequency f_{RFI} are the same. As such, both the parallel resonant frequency f_{RES} and the RF signal frequency f_{RFI} are at the frequency f_{B}. The impedance band 28 has been transposed so that the RF signal frequency f_{RFI} is in the middle of the impedance band 28. Thus, a greater portion of the RF input signal 20 is within the impedance band 28 of the impedance response 26. Furthermore, little to no noise is provided within the impedance band 28. Accordingly, precision tuning allows the tunable parallel resonator 16 to have a much higher Q factor.

It should be noted that in other embodiments, the tuning circuit 18 may not be capable of completely eliminating the phase difference between the RF output signal phase and the reference RF signal phase. This may depend on the tuning resolution of the tunable parallel resonator 16, the sensitivity of the tuning circuit 18, and/or the tuning control accuracy that can be provided by the tuning circuit 18. As such, tolerances for these parameters are generally based on application requirements and statistically acceptable error ranges.

Accordingly, while the embodiment shown in FIG. 2C eliminates the difference 30, in other embodiments, the difference 30 may not be completely eliminated or may simply be reduced to a smaller value, thereby improving performance. For example, the RF input signal 20 may be an RF transmission signal if the RF self-tuning amplification device 10 is implemented within a receiver chain of a transceiver. The RF input signal 20 may thus be an RF receive signal that is to be received from an antenna. The RF self-tuning amplification device 10 may thus be utilized to provide amplification to the RF input signal 20 received by the antenna.

In a discrete implementation of the tuning circuit 18, the tuning circuit 18 may adjust the control level of the tuning control signal 24 by a step size. This step size results in a shifting of the parallel resonant frequency f_{RES} by a discrete amount, so that the impedance band 28 is transposed toward the RF signal frequency f_{RFI}. However, the adjustment by the step size may not be sufficient to substantially eliminate the difference 30. Also, due to the discreteness of the step size, the difference 30 may never be entirely eliminated, since discrete changes can only be as accurate as the discrete step size permits. It may also require several time windows to substantially eliminate the difference 30.

In continuous implementations of the tuning circuit 18, the tuning circuit 18 may continuously tune the tunable parallel resonator 16, either during a time window or without reference to a time window. Changes to the control signal level of the tuning control signal 24 may be provided so as to have a continuous adjustment resolution. As such, the phase difference between the RF output signal phase and the reference RF signal (and thus the difference 30 between the parallel resonant frequency f_{RES} and the RF signal frequency f_{RFI}) may be substantially eliminated. However, it should be noted that this may not be the case. For example, this may depend on the sensitivity of the tuning circuit 18 and/or the tunable parallel resonator 16. Thus, while the parallel resonant frequency f_{RES} may be shifted so that the impedance band 28 is transposed toward the RF signal frequency f_{RFI}, there is the possibility of overshoot and undershoot. Also, there may be overshoot or undershoot if the tuning circuit 18 and/or the tunable parallel resonator 16 are not appropriately calibrated.

FIG. 2D is a graph illustrating the amplified RF output signal 22 in the frequency domain after the tuning circuit 18 has tuned the tunable parallel resonator 16 as described in FIG. 2C. In this example, the RF signal frequency of the amplified RF output signal 22 is at the frequency f_{B}. The RF signal frequency f_{RFO} of the amplified RF output signal 22 and the RF signal frequency f_{RFI} of the RF input signal 20 are thus the same. Note that frequency spectrum of the amplified RF output signal 22 shown in FIG. 2D is much less noisy than the amplified RF output signal 22 shown in FIG. 2B. Also, the maximum peak of the amplified RF output signal 22 at the RF signal frequency f_{RFO} has been increased from the magnitude M₀ to the magnitude M₁. Thus, greater power transfer is being provided by the RF self-tuning amplification device 10. Furthermore, since the phase difference between the RF output signal phase and the RF reference signal phase has been substantially eliminated, the source output impedance seen into the first RF amplifier 12A (shown in FIG. 1) and the load output impedance presented to the first RF amplifier 12A by the downstream RF circuitry may substantially match. In other words, matching of the output impedance may occur when the RF output signal phase and the RF reference signal phase are approximately equal.

Referring now to FIG. 1 and FIGS. 2E-2G, FIG. 2E illustrates the RF input signal 20 and the impedance response 26 in the frequency domain along with a plurality of different RF communication bands (referred to generically as RFCB, and specifically as RFCBₜ-RFCB_{z}). In FIG. 2E, the RF input signal 20 and the impedance response 26 provided by the tunable parallel resonator 16 are positioned along the frequency domain at the frequency f_{B}, as shown in FIG. 2C. The impedance response 26 and the RF input signal 20 are thus within the RF communication band RFCBₓ.

The discussion of FIGS. 2A-2D above describes precision tuning within the RF communication band RFCBₓ. However, RF band tuning may also be provided by the RF self-tuning amplification device 10. Thus, the tunable parallel resonator 16 may be tunable to shift the parallel resonant frequency f_{RES} and transpose the impedance band 28 into any of the RF communication bands RFCB. As such, the tuning circuit 18 is further configured to tune the tunable parallel resonator 16 (shown in FIG. 1) such that the parallel resonant frequency f_{RES} is shifted to the one of the plurality of different RF communication bands RFCB of the RF input signal 20. Accordingly, the tuning circuit 18 is operable to provide the impedance band 28 in any of the RF communication bands RFCB such that the RF signal frequency f_{RFI} is in any of the RF communication bands RFCB. To provide RF band tuning, the tuning circuit 18 may be configured to tune the tunable parallel resonator 16 such that the impedance band 28 is transposed to include the RF signal frequency f_{RFI} within the particular RF communication band RFCB. Furthermore, the tuning circuit 18 may be configured to tune the tunable parallel resonator 16 such that the parallel resonant frequency f_{RES} is positioned at the RF frequency f_{RFI} whenever the RF communication band RFCB of the RF input signal 20 is switched to any of the RF communication bands RFCB. For instance, the RF input signal 20 may be switched to the RF communication band RFCB_{w} and the RF signal frequency f_{RFI} may be placed at a frequency fₓ within the RF communication band RFCB_{w}.

FIG. 2F illustrates the RF input signal 20 in the frequency domain once the RF input signal 20 has been switched to the RF communication band RFCB_{w} and the RF signal frequency f_{RFI} has been placed at the frequency fₓ. As a result, there is a difference 38 between the parallel resonant frequency f_{RES} and the RF signal frequency f_{RFI} of the RF input signal 20. The tunable parallel resonator 16 is tunable to transpose the frequency passband into the RF communication band RFCB_{w} (and also into any of the other RF communication bands RFCBₜ-RFCBᵥ and RFCBₓ-RFCB_{z}) by shifting the parallel resonant frequency f_{RES} As a result of the difference 38, the tuning circuit 18 is responsive so as to tune the tunable parallel resonator 16. In this manner, the parallel resonant frequency f_{RES} is shifted to reduce the difference 38 between the parallel resonant frequency f_{RES} and the RF signal frequency f_{RFI}.

FIG. 2G illustrates one example of the impedance response 26 after the impedance band 28 has been shifted into the RF communication band RFCB_{w}. More specifically, the impedance band 28 is transposed to include the RF signal frequency f_{RFI} at the frequency fₓ. To do this, the tuning circuit 18 tunes the tunable parallel resonator 16 so that the parallel resonant frequency f_{RES} is shifted to be substantially at the RF signal frequency f_{RFI}, which is in the RF communication band RFCB_{w}. As such, the difference 38 (shown in FIG. 2F) has been reduced and, in this example, substantially eliminated.

In FIG. 2G, the RF communication bands RFCB include multiple cellular bands RFCBᵥ, RFCB_{w}, and RFCBₓ. For example, the RF communication band RFCBᵥ may be an EDGE cellular band, the RF communication band RFCB_{w} may be a GSM cellular band, and the RF communication band RFCBₓ may be an LTE cellular band. RF communication bands RFCB may also be included for other types of communication services. For example, the RF communication band RFCBₜ may be an FM broadcast band; the RF communication band RFCBᵤ may be a Global Positioning System (GPS) band; the RF communication band RFCB_{y} may be a Digital Video Broadcasting (DVB) band; and the RF communication band RFCB, may be a Wireless Local Area Network (WLAN) band or a Bluetooth band. As such, the RF self-tuning amplification device 10 can self-tune to different RF communication bands RFCB that provide different types of communication services.

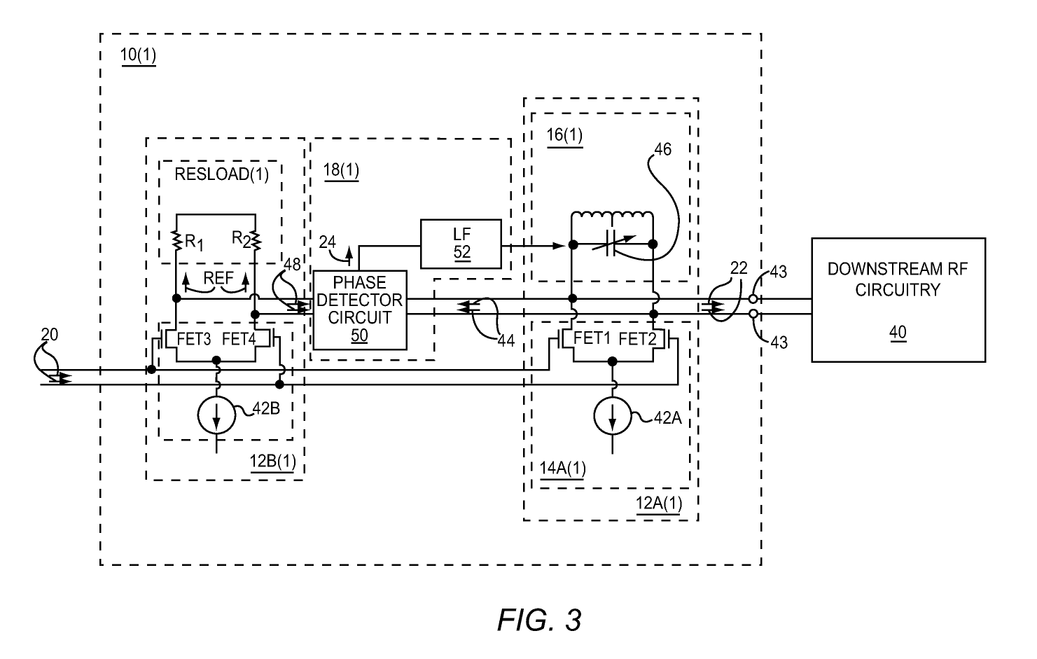

FIG. 3 illustrates one embodiment of an RF self-tuning amplification device 10(1). The RF self-tuning amplification device 10(1) is an exemplary embodiment of the RF self-tuning amplification device 10 shown in FIG. 1. The RF self-tuning amplification device 10(1) is coupled to downstream RF circuitry 40, which may be downstream RF circuitry in a transmission chain or a receiver chain. The RF self-tuning amplification device 10(1) includes a first RF amplifier 12A(1) and a reference RF amplifier 12B(1). The first RF amplifier 12A(1) has a first RF amplification circuit 14A(1) and the reference RF amplifier 12B(1) has a second RF amplification circuit 14B(1). The first RF amplifier 12A(1) also includes a tunable parallel resonator 16(1) coupled in shunt with respect to the first RF amplification circuit 14A(1). The first RF amplification circuit 14A(1) is configured to receive the RF input signal 20 and to amplify the RF input signal 20 so as to generate the amplified RF output signal 22 with the RF output signal phase. The tunable parallel resonator 16(1) is tunable so as to shift the RF output signal phase of the amplified RF output signal 22.

In this embodiment, the RF amplification circuit 14A(1) forms a first transconductor circuit that includes a pair of field effect transistors FET1, FET2 and a current source 42A. In the configuration illustrated in FIG. 3, the RF input signal 20 is received as a differential RF signal and the amplified RF output signal 22 is output as a differential RF signal. The gates of the field effect transistors FET1, FET2 provide an input terminus for the first RF amplifier 12A(1). The first RF amplifier 12A(1) includes an output terminus 43 operable to output the amplified RF output signal 22. As shown in FIG. 3, the output terminus 43 is connected to the downstream RF circuitry 40 to receive the amplified RF output signal 22 from the first RF amplifier 12A(1).

With regard to the term “terminus,” terminus refers to any component or set of components configured to input and/or output RF signals. For example, in FIG. 3, the RF input signal 20 and the amplified RF output signal 22 are both differential signals. Accordingly, a pair of terminals or nodes is configured to externally input and/or output the RF differential signals (i.e., the gates of the field effect transistors FET1, FET2 for the RF input signal 20 and the pair of terminals in the output terminus 43 for the amplified RF output signal 22). However, in other embodiments, the RF input signal 20 and/or the amplified RF output signal 22 may be single-ended RF signals. As such, a single terminal or node may be provided to externally input and/or output the single-ended RF signals.

The first RF amplifier 12A(1) is configured to present an output source impedance at the output terminus 43. As shown in FIG. 3, the output terminus 43 is coupled to the downstream RF circuitry 40 such that the first RF amplifier 12A(1) is operable to output the amplified RF output signal 22 to the downstream RF circuitry 40. Thus, the downstream RF circuitry 40 presents an output load impedance at the output terminus 43. Both the output source impedance and the output load impedance are complex impedances. These complex impedances also vary based on the frequency, and thus change as the RF signal frequency of the RF input signal 20 varies. For the RF signal frequency of the RF input signal 20, if the difference between the parallel resonant frequency of the tunable parallel resonator 16(1) and the RF signal frequency of the RF input signal 20 is substantially eliminated, the output source impedance of the first RF amplifier 12A(1) may be matched to the output load impedance of the downstream RF circuitry 40. This occurs when the RF output signal phase of the amplified RF output signal 22 is set to the value which provides the output source impedance as being equal to a complex conjugate of the output load impedance.

Since the tunable parallel resonator 16(1) is coupled in shunt with respect to the first RF amplification circuit 12A(1), the noise outside of the impedance band of the tunable parallel resonator 16(1) is filtered by the tunable parallel resonator 16(1). At the parallel resonant frequency, the tunable parallel resonator 16(1) essentially operates as an open circuit, and thus none (or a relatively small/negligible amount) of the signal components from the amplified RF output signal 22 are passed to the tunable parallel resonator 16(1) at the parallel resonant frequency. Rather, the amplified RF output signal 22 is passed to the output terminus 43 and then to the downstream RF circuitry 40.

The reference for the amplified RF output signal 22 is provided by the reference RF amplifier 12B(1). The reference RF amplifier 12B(1) has the second RF amplification circuit 14B(1) and a resistive load RESLOAD(1). The second RF amplification circuit 14B(1) is configured to receive the RF input signal 20 and to amplify the RF input signal 20 so as to generate the reference RF signal REF with the reference RF signal phase. The second RF amplification circuit 14B(1) forms a second transconductor circuit that includes a pair of field effect transistors FET3, FET4 and a current source 42B. In this embodiment, the first transconductor circuit of the first RF amplification circuit 14A(1) is identical to the second transconductor circuit of the second RF amplification circuit 14B(1).

A tuning circuit 18(1) is coupled to receive a feedback signal 44 having magnitude and phase characteristics indicative of the magnitude and phase characteristics of the amplified RF output signal 22. In this embodiment, the tuning circuit 18(1) is operably associated with the tunable parallel resonator 16(1). The tuning circuit 18(1) adjusts the control signal level of the tuning control signal 24 such that the parallel resonant frequency of the tunable parallel resonator 16(1) is shifted to reduce the phase difference between the RF output signal phase and the reference RF signal phase. As shown in FIG. 3, the tunable parallel resonator 16(1) is provided to filter the amplified RF output signal 22 generated by the RF amplification circuit 12(1). In this example, the tunable parallel resonator 16(1) is provided simply as an LC resonant circuit with a variable reactive component 46. The stopband of the tunable parallel resonator 16(1) is thus provided as a notch with a relatively high Q factor. The variable reactive component 46 shown in FIG. 3 is a variable capacitive component, such as a programmable capacitor array and/or the like, and is coupled in parallel with respect to an inductive element. The variable reactive component 46 provides a variable reactive impedance (in this case, a capacitance). The parallel resonant frequency of the tunable parallel resonator 16(1) is thus set in accordance with the reactive impedance level of the variable reactive impedance. Since the reactive impedance level is variable, the parallel resonant frequency can be shifted. For example, since the variable reactive component 46 shown in FIG. 3 is a variable capacitive component, the variable capacitance level of this capacitance is adjustable. Adjusting the variable capacitance level shifts the parallel resonant frequency of the tunable parallel resonator 16(1).

Additionally, the tuning circuit 18(1) is coupled to receive a feedback signal 48 having magnitude and phase characteristics indicative of the magnitude and phase characteristics of the reference RF signal REF. Shifting the parallel resonant frequency transposes the parallel resonant frequency of the tunable parallel resonator 16(1) and adjusts the RF output signal phase of the amplified RF output signal 22 toward the reference RF signal phase of the reference RF signal REF. So that the tuning circuit 18(1) is configured to tune the tunable parallel resonator 16(1), the tuning circuit 18(1) is configured to adjust the reactive impedance level provided by the variable reactive component 46 and shift the parallel resonant frequency of the tunable parallel resonator 16(1). More specifically, the tuning circuit 18(1) is configured to adjust the reactive impedance level so that the parallel resonant frequency is shifted to reduce the phase difference between the RF output signal phase of the amplified RF output signal 22 and the reference RF signal phase of the reference RF signal REF.

As shown in FIG. 3, the tuning circuit 18(1) includes a phase detector circuit 50. The phase detector circuit 50 is configured to receive the feedback signal 48 that is based on the reference RF signal REF. The feedback signal 48 therefore has a phase and a magnitude indicative of the reference RF phase and the reference RF magnitude of the reference RF signal REF. The second RF amplification circuit 14B(1) is a replica of the first RF amplification circuit 14A(1). Accordingly, the second RF amplification circuit 14B(1) is sized and otherwise configured so that the reference RF phase of the reference RF signal REF is at the value of the RF output signal phase of the amplified RF output signal 22 when the output source impedance matches the output load impedance. In this embodiment, the resistive load RESLOAD(1) includes resistors R₁ and R₂, each coupled to one of the drains of field effect transistors FET3, FET4, respectively. As such, the resistive load RESLOAD(1) provides a resistive and nonreactive impedance. As such, the resistive impedance of the resistors R₁ and R₂ does not shift the phase of the reference RF signal REF so that the reference RF amplifier 12B(1) has the reference RF signal phase.

The phase detector circuit 50 is coupled to the first RF amplifier 12A(1) and to the reference RF amplifier 12B(1) so as to receive the feedback signal 44 from the first RF amplifier 12A(1) and the feedback signal 48 from the reference RF amplifier 12B(1). To adjust the reactive impedance level of the reactive impedance provided by the variable reactive component 46, the phase detector circuit 50 is configured to detect the reference RF phase of the reference RF signal REF from the feedback signal 48. Additionally, the phase detector circuit 50 is configured to detect the RF output signal phase of the amplified RF output signal 22 from the feedback signal 44. The tuning circuit 18(1) is configured to shift the parallel resonant frequency of the tunable parallel resonator 16(1) to reduce the phase difference between the RF output signal phase and the reference RF signal phase. As a result, the RF self-tuning amplification device 10(1) provides a phase shift that decreases the phase difference and improves matching between the first RF amplifier 12A(1) and the downstream RF circuitry 40.

In this embodiment, to decrease the phase difference between the reference RF signal phase and the RF output signal phase, the phase detector circuit 50 is configured to generate the tuning control signal 24. If there is a phase difference, the control signal level of the tuning control signal 24 is adjusted accordingly. This, in turn, drives the variable reactive component 46 of the tunable parallel resonator 16(1) by adjusting the reactive impedance level of the reactive impedance. The parallel resonant frequency of the tunable parallel resonator 16(1) is thus shifted to decrease the phase difference between the RF output signal phase and the reference RF signal phase, thereby also reducing the difference between the parallel resonant frequency and the RF signal frequency of the RF input signal 20. A low-pass filter (LF) 52 may be provided between the phase detector circuit 50 and the variable reactive component 46 to remove high-frequency components of the tuning control signal 24, and also to proportion the control signal level of the tuning control signal 24 so that the tuning control signal 24 can drive the variable reactive component 46 appropriately. As such, the RF self-tuning amplification device 10(1) does not have to utilize clock signals or data signals to tune the tunable parallel resonator 16(1).

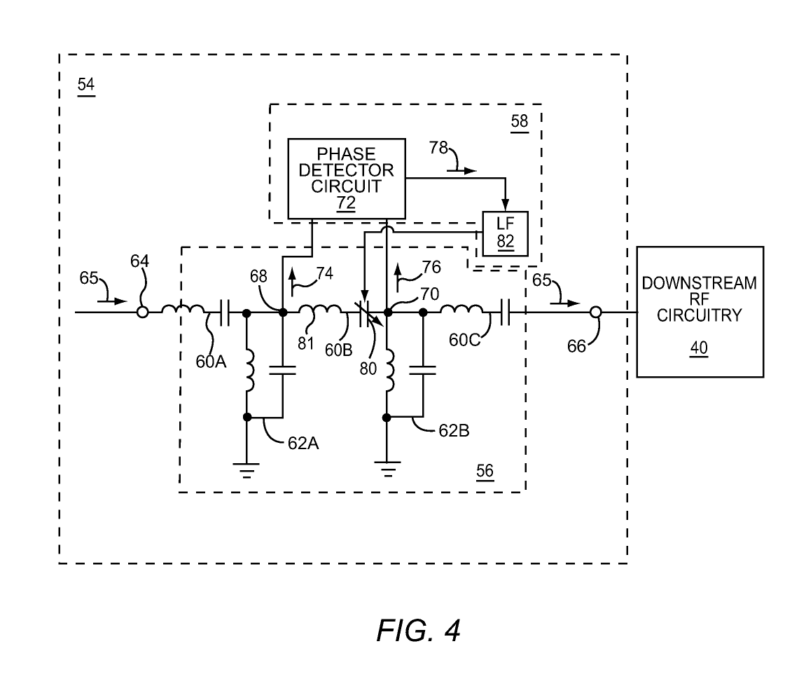

FIG. 4 illustrates a circuit diagram of one embodiment of a self-tuning RF bandpass filter 54. In this embodiment, the self-tuning RF bandpass filter 54 includes a tunable bandpass filter 56 and a tuning circuit 58. In FIG. 4, the tunable bandpass filter 56 includes series resonators 60A, 60B, and 60C, and parallel resonators 62A, 62B. The self-tuning RF bandpass filter 54 includes an input terminus 64 for receiving an RF signal 65 and an output terminus 66 for outputting the RF signal 65 to the downstream RF circuitry 40.

The tunable bandpass filter 56 is coupled between the input terminus 64 and the output terminus 66. The RF signal 65 is received by the tunable bandpass filter 56 at the input terminus 64, and, after filtering, is output at the output terminus 66. The parallel resonators 62A, 62B are each coupled in shunt between the input terminus 64 and the output terminus 66, while the series resonators 60A, 60B, and 60C are connected in series between the input terminus 64 and the output terminus 66. The parallel resonators 62A, 62B each operate approximately as open circuits at resonance. In contrast, the series resonators 60A, 60B, and 60C each operate as short circuits at resonance. The tunable bandpass filter 56 is configured to filter the RF signal 65 in accordance with a frequency response of the tunable bandpass filter 56. In particular, the frequency response of the tunable bandpass filter 56 defines a frequency passband. The tunable bandpass filter 56 is configured to be tunable so as to transpose the frequency passband of the tunable bandpass filter 56.

To allow for tuning of the tunable bandpass filter 56, the series resonator 60B in the tunable bandpass filter 56 is a tunable series resonator. The series resonator 60B thus has a frequency response that defines a series resonant frequency and is tunable so as to shift the series resonant frequency. The series resonator 60B is coupled in the tunable bandpass filter 56 so as to define an input node 68 and an output node 70. The input node 68 is operable to receive the RF signal 65 from the input terminus 64 and the output node 70 is operable to transmit the RF signal 65 to the output terminus 66. Ideally, at the series resonant frequency, the series resonator 60B operates as a short circuit, and thus the RF signal 65 simply passes from the input node 68 to the output node 70. In practice, the frequency response of the series resonator 60B defines an impedance minimum at the series resonant frequency. If an impedance transformation of an input impedance at the input terminus 64 matches an output impedance at the output terminus 66, the series resonant frequency of the series resonator 60B should be at or near an RF frequency of the RF signal 65. Accordingly, to adjust the impedance transformation to provide matching, a first RF signal phase of the RF signal 65 at the input node 68 should be approximately the same as a second RF signal phase of the RF signal 65 at the output node 70.

The tuning circuit 58 is operable to tune the series resonator 60B and shift the series resonant frequency so as to reduce a phase difference between a first RF signal phase of the RF signal 65 at the input node 68 and a second RF signal phase of the RF signal 65 at the output node 70. This sets the series resonant frequency of the series resonator 60B to the RF frequency of the RF signal 65. In this embodiment, the tuning circuit 58 includes a phase detector circuit 72 to tune the series resonator 60B. To do this, the phase detector circuit 72 is configured to receive a feedback signal 74 that indicates the first RF signal phase at the input node 68 and to receive a feedback signal 76 that indicates the second RF signal phase at the output node 70. The phase detector circuit 72 is configured to detect the first RF signal phase of the RF signal 65 at the input node 68 from the feedback signal 74 and the second RF signal phase of the RF signal 65 at the output node 70 from the feedback signal 76. At the center frequency of the frequency passband of the tunable bandpass filter 56, the series resonators 60A, 60B, and 60C operate as short circuits, while the parallel resonators 62A and 62B operate as open circuits. Accordingly, this means that the RF signal 65 should have no (or a very small/negligible) phase difference at the input node 68 and at the output node 70. Using the feedback signal 74 and the feedback signal 76, the phase detector circuit 72 detects the first RF signal phase of the RF signal 65 at the input node 68, and detects the second RF signal phase of the RF signal 65 at the output node 70.

The phase detector circuit 72 then drives the series resonator 60B so as to decrease the phase difference between the first RF signal phase of the RF signal 65 at the input node 68 and the second RF signal phase of the RF signal 65 at the output node 70. When decreasing the phase difference, the tuning circuit 58 is configured to tune the series resonator 60B by shifting the series resonant frequency of the series resonator 60B. In the embodiment shown in FIG. 4, the phase detector circuit 72 generates the tuning control signal 78. If there is a phase difference between the signal phase of the RF signal 65 at the input node 68 and the signal phase of the RF signal 65 at the output node 70, the phase detector circuit 72 generates a tuning control signal 78 and adjusts a control signal level of the tuning control signal 78 by a determined amount. The tuning control signal 78 is configured to control a variable reactive component 80 in the series resonator 60B. In this example, the variable reactive component 80 is a variable capacitive component. The series resonator 60B further includes an inductive component 81 connected in series with the variable capacitive component.

Upon adjusting the control signal level of the tuning control signal 78, a reactive impedance level of a reactive impedance provided by the variable reactive component 80 is adjusted. Once there is little to no phase difference, the series resonant frequency of the series resonator 60B is substantially at the RF signal frequency of the RF signal 65. As a result, the reactive impedance level of the variable reactive component 80 does not require further adjustments, since the series resonant frequency does not need to be shifted further. An LF 82 is provided between the variable reactive component 80 and the phase detector circuit 72 to remove high-frequency signal components from the tuning control signal 78. If the phase difference between the first RF signal phase of the RF signal 65 at the input node 68 and the second RF signal phase of the RF signal 65 at the output node 70 is substantially eliminated, the output impedance at the output terminus 66 has been matched by the impedance transformation provided by the tunable bandpass filter 56 of the input impedance at the input terminus 64.

Those skilled in the art will recognize improvements and modifications to the preferred embodiments of the present disclosure. All such improvements and modifications are considered within the scope of the concepts disclosed herein and the claims that follow.

What is claimed is:

1. A radio frequency (RF) self-tuning amplification device comprising:
a first RF amplifier operable to receive an RF input signal and output an amplified RF output signal with an RF output signal phase, the first RF amplifier comprising a first RF amplification circuit configured to amplify the RF input signal so that the first RF amplifier generates the amplified RF output signal, and a tunable parallel resonator coupled in shunt with respect to the first RF amplification circuit, wherein the tunable parallel resonator is tunable so as to adjust the RF output signal phase of the amplified RF output signal;
a reference RF amplifier operable to receive the RF input signal, the reference RF amplifier comprising a second RF amplification circuit configured to amplify the RF input signal so that the reference RF amplifier generates a reference RF signal and a resistive load operably associated with the second RF amplification circuit such that the reference RF signal is generated by the reference RF amplifier with a reference RF signal phase; and
a tuning circuit configured to tune the tunable parallel resonator and adjust the RF output signal phase so as to reduce a phase difference between the RF output signal phase and the reference RF signal phase.

2. The RF self-tuning amplification device of claim 1 wherein:
the tunable parallel resonator has a frequency response that defines a parallel resonant frequency; and
the tunable parallel resonator is tunable such that the parallel resonant frequency is shiftable, wherein shifting the parallel resonant frequency adjusts the RF output signal phase.

3. The RF self-tuning amplification device of claim 2 wherein the RF input signal operates at an RF signal frequency within an RF communication band and the amplified RF output signal has a magnitude peak when the parallel resonant frequency is set to the RF signal frequency of the RF input signal.

4. The RF self-tuning amplification device of claim 2 wherein:
the tunable parallel resonator has the frequency response that defines the parallel resonant frequency such that the tunable parallel resonator has an impedance peak at the parallel resonant frequency; and
the tunable parallel resonator is further tunable so as to transpose the impedance peak into an RF communication band by shifting the parallel resonant frequency.

5. The RF self-tuning amplification device of claim 2 wherein:
the RF input signal can be received in any one of a plurality of different RF communication bands such that an RF signal frequency of the RF input signal is in the one of the plurality of different RF communication bands;
the tunable parallel resonator is further tunable to shift the parallel resonant frequency of the tunable parallel resonator into any of the plurality of different RF communication bands; and
the tuning circuit is further configured to tune the tunable parallel resonator such that the parallel resonant frequency is shifted to the one of the plurality of different RF communication bands.

6. The RF self-tuning amplification device of claim 5 wherein the plurality of different RF communication bands comprises multiple cellular bands.

7. The RF self-tuning amplification device of claim 6 wherein the plurality of different RF communication bands further comprises one or more of a Wireless Local Area Network (WLAN) band, a Bluetooth® band, a Global Positioning System (GPS) band, an FM broadcast band, and a Digital Video Broadcasting (DVB) band.

8. The RF self-tuning amplification device of claim 1 wherein the tuning circuit is configured to tune the tunable parallel resonator so as to substantially eliminate the phase difference between the RF output signal phase and the reference RF signal phase.

9. The RF self-tuning amplification device of claim 1 wherein:
the tunable parallel resonator comprises a variable reactive component that provides a reactive impedance wherein a parallel resonant frequency of the tunable parallel resonator is set in accordance with a reactive impedance level of the reactive impedance and, so that the tunable parallel resonator is tunable, the variable reactive component is configured such that the reactive impedance level of the reactive impedance is adjustable so as to shift the parallel resonant frequency.

10. The RF self-tuning amplification device of claim 9 wherein so that the tuning circuit is configured to tune the tunable parallel resonator, the tuning circuit is configured to adjust the reactive impedance level of the reactive impedance such that the parallel resonant frequency is shifted to reduce the phase difference between the RF output signal phase and the reference RF signal phase.

11. The RF self-tuning amplification device of claim 9 wherein the tuning circuit comprises a phase detector circuit, wherein the phase detector circuit is operably associated with the first RF amplification circuit and the second RF amplification circuit, and wherein the phase detector circuit is configured to:
detect the reference RF signal phase of the reference RF signal;
detect the RF output signal phase of the amplified RF output signal; and
drive the variable reactive component so as to reduce the phase difference between the RF output signal phase and the reference RF signal phase.

12. The RF self-tuning amplification device of claim 11 wherein the phase detector circuit drives the variable reactive component until the RF output signal phase is substantially equal to the reference RF signal phase.

13. The RF self-tuning amplification device of claim 1 wherein the first RF amplifier further comprises an output terminus operable to output the amplified RF output signal and wherein:
the first RF amplifier is configured to present an output source impedance at the output terminus; and
the output terminus is coupled to downstream RF circuitry such that the first RF amplifier is operable to output the amplified RF output signal to the downstream RF circuitry, and the downstream RF circuitry presents an output load impedance at the output terminus, wherein the output source impedance of the downstream RF circuitry is matched if the difference between a parallel resonant frequency of the tunable parallel resonator and an RF signal frequency of the RF input signal is substantially eliminated.

14. The RF self-tuning amplification device of claim 1 wherein:
the tunable parallel resonator comprises a tunable bandpass filter operably associated with the first RF amplification circuit such that a frequency response of the tunable parallel resonator further defines a parallel resonant frequency, the tunable bandpass filter being configured to be tunable to shift the parallel resonant frequency; and
to tune the tunable parallel resonator such that the parallel resonant frequency is shifted to reduce a difference between the parallel resonant frequency and an RF signal frequency of the RF input signal, the tuning circuit is configured to tune the tunable bandpass filter so as to transpose the frequency passband such that the parallel resonant frequency is shifted toward the RF signal frequency.

15. The RF self-tuning amplification device of claim 14 wherein:
the tunable bandpass filter is the tunable parallel resonator;
the parallel resonant frequency is at a center of the frequency passband; and
the tunable bandpass filter is coupled to receive the amplified RF output signal from the first RF amplification circuit.

16. The RF self-tuning amplification device of claim 1 wherein the first RF amplification circuit and the second RF amplification circuit are substantially identical.

17. The RF self-tuning amplification device of claim 1 wherein the first RF amplification circuit comprises a first transconductive circuit and the second RF amplification circuit comprises a second transconductive circuit.

18. A method of amplification for a radio frequency (RF) input signal operating at an RF signal frequency, comprising:
amplifying the RF input signal with a first RF amplifier so as to generate an amplified RF output signal with a first RF amplification circuit, wherein a tunable parallel resonator is coupled in shunt with respect to the first RF amplification circuit;
amplifying the RF input signal with a second RF amplification circuit so as to generate a reference RF signal, wherein a resistive load is operably associated with the second RF amplification circuit such that the reference RF signal is generated by a reference RF amplifier with a reference RF signal phase; and
adjusting an RF output signal phase of the amplified RF output signal by tuning the tunable parallel resonator so as to reduce a phase difference between the RF output signal phase and the reference RF signal phase.

19. The method of claim 18 wherein adjusting the RF output signal phase of the amplified RF output signal by tuning the tunable parallel resonator so as to reduce the phase difference between the RF output signal phase and the reference RF signal phase comprises:
detecting the reference RF signal phase of the reference RF signal;
detecting the RF output signal phase of the amplified RF output signal; and
while detecting both the reference RF signal phase and the RF output signal phase, shifting a parallel resonant frequency defined by a frequency response of the tunable parallel resonator until the phase difference is substantially eliminated.

20. A self-tuning bandpass filtering circuit for a radio frequency (RF) signal comprising:
an input terminus for receiving the RF signal;
an output terminus for outputting the RF signal;
a tunable bandpass filter coupled between the input terminus and the output terminus, the tunable bandpass filter comprising a tunable series resonator having a frequency response that defines a series resonant frequency, wherein the tunable series resonator is tunable so as to shift the series resonant frequency, and wherein the tunable series resonator is coupled in the tunable bandpass filter so as to define an input node and an output node, wherein the input node is operable to receive the RF signal from the input terminus and the output node is operable to transmit the RF signal to the output terminus; and
a tuning circuit operable to tune the tunable series resonator and shift the series resonant frequency so as to reduce a phase difference between a first RF signal phase of the RF signal at the input node and a second RF signal phase of the RF signal at the output node.
